(19) United States
(12) Patent Application Publication
(10) Pub. No.: US 2016/0243386 A1
(43) Pub. Date: Aug. 25, 2016

(54) FIRE SUPPRESSION SOLUTION AND APPARATUS

(71) Applicant: Jerome A. Rodder, Los Altos, CA (US)

(72) Inventor: Jerome A. Rodder, Los Altos, CA (US)

(21) Appl. No.: 15/048,873

(22) Filed: Feb. 19, 2016

Related U.S. Application Data
(60) Provisional application No. 62/120,739, filed on Feb. 25, 2015.

(51) Int. Cl. A62C 5/00

(52) U.S. Cl. CPC A62C 5/004

(57) ABSTRACT

A fire suppression solution comprising a saturated solution of either sodium carbonate or sodium bicarbonate and a dilute acid solution for a fire suppression apparatus having a first container for delivery of the saturated solution of sodium carbonate or sodium bicarbonate, a second container for delivery of the dilute acid solution, a first hose connected to the first container and a second hose connected to the second container such that when the saturated solution of sodium carbonate or sodium bicarbonate is delivered out of the first hose and mixes with the dilute acid solution delivered from the second hose carbon dioxide is produced to smother a fire.

### CROSS REFERENCE TO RELATED APPLICATIONS

This application claims priority to and the benefit of U.S. Provisional Patent Application No. 62/120,739 filed Feb. 25, 2015, the entire contents thereof are incorporated herein by reference.

### BACKGROUND OF THE INVENTION

The present invention generally relates to fire suppression compositions and systems for the extinguishment of fires, and more particularly is concerned with an apparatus to produce carbon dioxide which in combination with water extinguishes fire.

Fire extinguishing systems, such as water sprinkling systems, are used widely in many different environments such as homes, offices or commercial buildings. Common features of these systems include the use of a storage container or source of a pressurized water connected to a discharged outlet in the area to be protected. A problem with these sprinkler systems or other traditional methods of firefighting such as hoses attached to a hydrant, is that because fires in buildings can require large amounts of water and hours to extinguish, the water goes to a lower level within the building before it vaporizes to steam that would put out the fire. The result is that a great deal of water damage occurs to the structure and extensive amount of time is needed to extinguish the fire.

Another problem with prior fire extinguishing systems is that they are complex and inflexible and do not provide a simple comprehensive solution to extinguish fires in an enclosed building.

Consequently a fire suppression composition and apparatus which addresses the problems of previous systems is needed which reduces the amount of water and time necessary to extinguish a fire.

### SUMMARY OF THE INVENTION

The present invention provides a fire extinguishing apparatus and composition which addresses the drawbacks of previous solutions. The fire suppression apparatus of the present invention is designed to create a large amount of carbon dioxide to smother the fire in combination with water. The apparatus provides two sources, which can be hoses each having a distinct chemical. One of the hoses incorporates a saturated solution of either sodium carbonate or sodium bicarbonate and the second hose would contain a dilute acid solution such as hydrochloric acid. When the contents of each hose are directed towards a fire and the streams thereof meet, carbon dioxide is released.

In another example the apparatus can incorporate two small tubes banded to a fire hose. Using a flow meter and a high pressure pump the chemicals from each tube can be discharged at the nozzle end of the fire hose to create the carbon dioxide. Alternatively sodium carbonate or sodium bicarbonate can be injected into the water stream of the fire hose and only one small hose would then need to be attached to the fire hose for dispensing the dilute acid solution to produce the carbon dioxide. Another embodiment can include the use of two fire engines, each having a fire hose wherein each of the fire engines can incorporate one of the chemicals which then would be mixed when the streams from the hoses meet. If a single fire engine is utilized, an auxiliary centrifugal pump can be incorporated into the system to provide the second chemical.

The advantage of the present invention is that the apparatus utilizes water to cool the flames while producing carbon dioxide to help smother the fire thereby reducing the amount of water and time necessary to extinguish the fire. These and other aspects of the invention can be more fully understood with reference to the accompanying drawings.

### BRIEF DESCRIPTION OF THE DRAWINGS

FIG. 1 is a schematic illustration of a fire suppression apparatus of the present invention;

FIG. 2 is a schematic illustration of an alternative embodiment fire suppression apparatus;

FIG. 3 is a schematic illustration of another embodiment fire suppression apparatus;

FIG. 4 is a schematic illustration of another alternative embodiment fire suppression apparatus; and

FIG. 5 is a schematic illustration of another alternative embodiment fire suppression apparatus.

### DETAILED DESCRIPTION

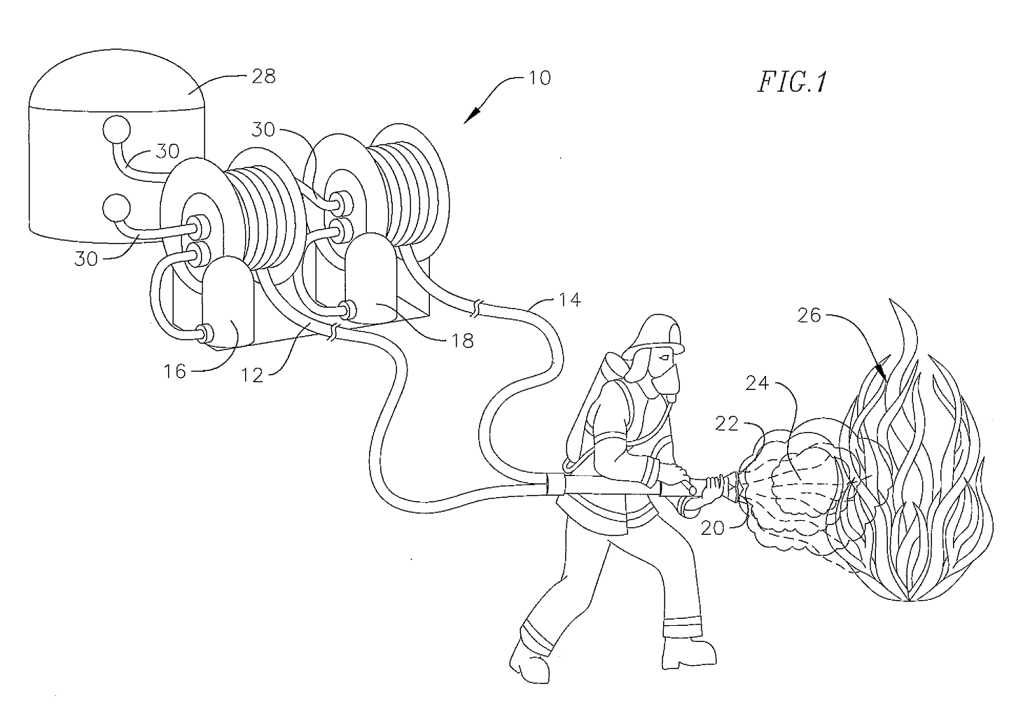

Referring to FIG. 1, a fire suppression apparatus 10 is illustrated. The fire suppression apparatus comprises a first hose 12 and a second hose 14. Each of first hose 12 and second hose 14 deliver a water based solution of two separate chemicals. For example, first hose 12 can deliver a saturated solution of either sodium carbonate or sodium bicarbonate, also known as baking soda, which is introduced to hose 12 through a first container 16. In this example second hose 14 would deliver a dilute acid solution such as hydrochloric acid delivered from a second container 18. As the saturated solution 20 of either sodium carbonate or sodium bicarbonate mixes with the dilute acid solution 22 carbon dioxide 24 is released. The combination of water and carbon dioxide cools and smothers the flames 26 thereby extinguishing the fire. A water source 28 delivers water to the first and second containers by a conduit 30.

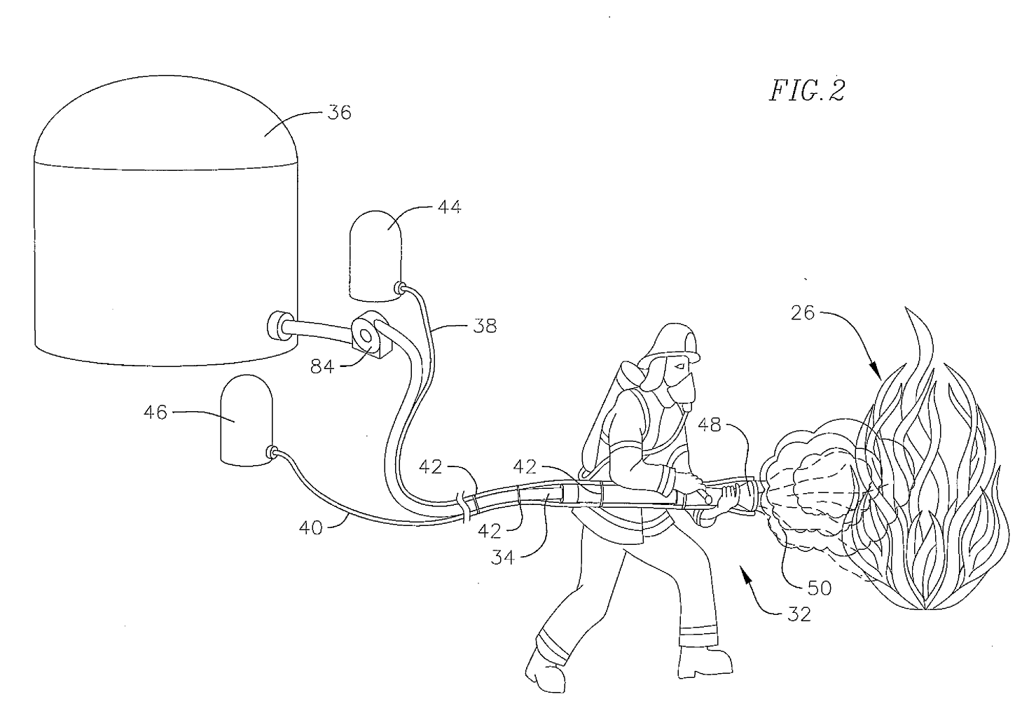

An alternative embodiment fire suppression apparatus 32 is illustrated in FIG. 2. In this embodiment, a single water hose 34 attached to a water source 36 includes two smaller hoses 38 and 40 banded to the hose for the delivery of the chemicals. Hose 38, for example is attached to a container 44 for the delivery of the saturated solution of sodium carbonate or sodium bicarbonate and small hose 40 delivers the dilute acid solution from container 46. Water through the water hose and the chemicals through small hoses 38 and 40 combine at nozzle 48 to produce the carbon dioxide 50.

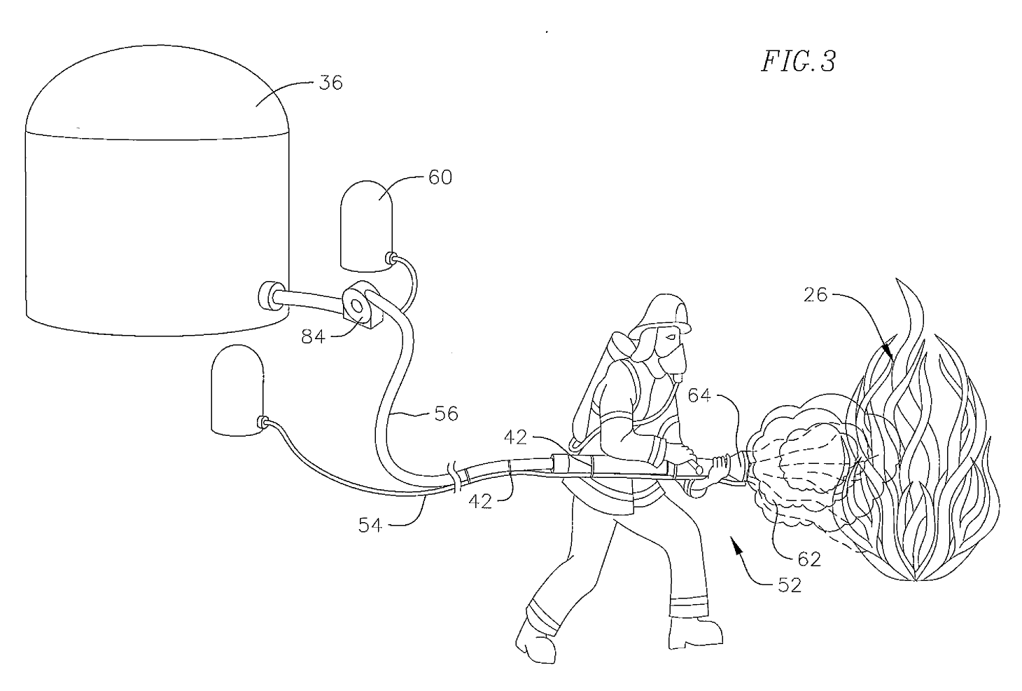

FIG. 3 illustrates another alternative embodiment fire suppression apparatus 52 which is similar to fire suppression apparatus 32 with the exception that only one small hose 54 is banded to the water hose 56. Small hose 54 delivers one of the chemicals, such as, for example, the saturated solution of sodium carbonate or sodium bicarbonate and the dilute acid solution is injected directly into the water hose 56 by container 60. The carbon dioxide 62 is formed at nozzle 64.

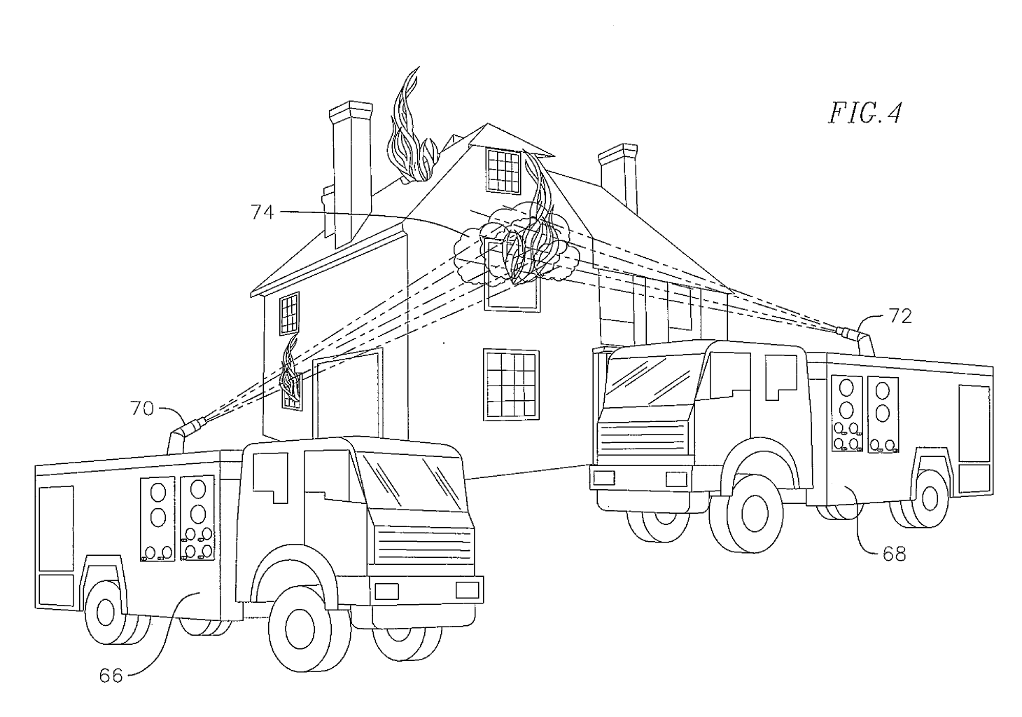

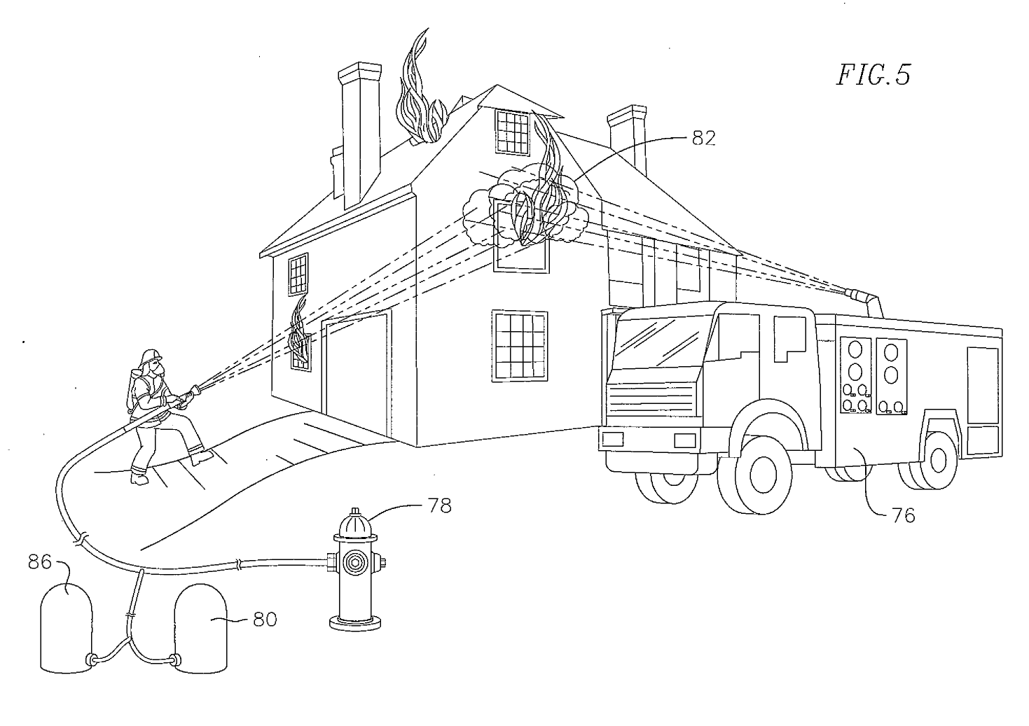

The fire suppression apparatus of the present invention is equally applicable to mobile systems such as illustrated in FIG. 4. In FIG. 4 fire engines 66 and 68 each include a water delivery system 70, 72 respectively. Each of the water delivery systems 70, 72 contain one of the saturated solution of sodium carbonate or sodium bicarbonate and the other includes the dilute acid solution such that when the solutions combine carbon dioxide 74 is created. Alternatively as illustrated in FIG. 5 if only a single fire engine 76 is utilized, which could provide one of the chemical solutions, a second source such as a fire hydrant 78 can include a chemical source 80 to provide the other of the components such that when combined carbon dioxide 82 is created. As in any of these systems, additional components can be incorporated such as flow meters 84 (FIG. 2) and various auxiliary pumps 86 to provide the necessary water pressure.

These and other aspects of the present invention have been described with respect to various embodiments thereof, however it is to be understood that variations can be made therein which are within the full intended scope of the invention as here and after claimed.

What is claimed is:

1. A fire suppression apparatus comprising:
a first container for delivery of a saturated solution of sodium carbonate or sodium bicarbonate;
a second container for delivery of a dilute acid solution;
a first hose connected to the first container; and
a second hose connected to the second container,
wherein when the saturated solution of sodium carbonate or sodium bicarbonate is delivered out of the first hose and mixes with the dilute acid solution delivered from the second hose, carbon dioxide is produced to smother a fire.

2. The apparatus of claim 1 wherein the dilute acid solution contains hydrochloric acid.

3. The apparatus of claim 1 further comprising a water hose wherein the first hose and the second hose are connected thereto.

4. The apparatus of claim 1 further comprising an auxiliary pump.

5. The apparatus of claim 4 wherein the auxiliary pump is a high pressure pump.

6. The apparatus of claim 1 further comprising a flow meter.

7. The apparatus of claim 1 wherein the first hose is also a water hose.

8. The apparatus of claim 1 further comprising at least one nozzle.

9. The apparatus of claim 1 wherein the first hose is connected to a first fire engine.

10. The apparatus of claim 1 wherein the second hose is connected to a second fire engine.

11. The apparatus of claim 9 wherein the second hose is connected to a secondary water source.
